(19) United States
(12) Patent Application Publication
(10) Pub. No.: US 2012/0321942 A1
(43) Pub. Date: Dec. 20, 2012

(54) ELECTRODE ASSEMBLY AND SECONDARY BATTERY USING THE SAME

(75) Inventor: Chang-Bum Ahn, Yongin-si (KR)

(73) Assignee: Samsung SDI Co., Ltd., Yongin-si (KR)

(21) Appl. No.: 13/485,048

(22) Filed: May 31, 2012

(30) Foreign Application Priority Data
Jun. 16, 2011 (KR) 10-2011-0058508

(51) Int. Cl. H01M 4/75; H01M 2/30; H01M 2/04

(52) U.S. Cl. 429/179; 429/211; 429/185

(57) ABSTRACT

An electrode assembly comprises a first electrode plate having a first electrode tab coupled to one end portion thereof; a second electrode plate having a second electrode tab coupled to one end portion thereof; and a separator interposed between the first and second electrode plates. In the electrode assembly, the first electrode tab is formed in the shape of a rod so as to be positioned at the center of the electrode assembly.

### RELATED APPLICATIONS

This application claims priority to and the benefit of Korean Patent Application No. 10-2011-0058508, filed on Jun. 16, 2011, in the Korean Intellectual Property Office, the entire content of which is incorporated herein by reference.

### BACKGROUND

1. Field

Embodiments of the present invention relate to an electrode assembly and a secondary battery using the same, and more particularly, to an electrode assembly and a secondary battery using the same and capable of implementing high-power battery applications.

2. Description of the Related Technology

In general, electrode assemblies used for secondary batteries may be manufactured in various shapes. Among these electrode assemblies, a wound-type electrode assembly is typically formed by providing positive and negative electrode plates to which flat-shaped positive and negative electrode tabs are respectively fused, interposing a separator between the positive and negative electrode plates, and then winding the positive and negative electrode plates and the separator.

A conventional process of winding an electrode assembly will be described. First, a winding core is disposed at a portion at which the winding of the electrode assembly is started, and a positive electrode plate, a negative electrode plate and a separator are wound together. Then, if the winding is completed, the winding core is removed to the outside of the electrode assembly. However, the shape of the wound positive electrode plate, the negative electrode plate and the separator, may be deformed from the process of removing the winding core to the outside of the electrode assembly.

When a secondary battery using the electrode assembly configured as described above is charged or discharged, heat may be generated from the secondary battery due to the high resistance of the positive electrode, and hence the secondary battery may become weak to safety. Therefore, the wound-type electrode assembly has limitations in manufacturing medium- and large-sized batteries used for high power applications.

### SUMMARY

Embodiments provide an electrode assembly and a secondary battery using the same capable of inhibiting deformation of the electrode assembly when winding the electrode assembly using a rod-shaped electrode tab.

Embodiments also provide an electrode assembly and a secondary battery using the same capable of inhibiting heat generated from the battery by enlarging the area of an electrode tab.

According to an aspect of the present invention, an electrode assembly includes: a first electrode plate having a first electrode tab coupled to an end portion of the first electrode plate; a second electrode plate having a second electrode tab coupled to an end portion of the second electrode plate; and a separator interposed between the first and second electrode plates, wherein the first electrode tab is formed in a rod shape so as to be positioned at the center of the electrode assembly.

The first electrode tab may have a positive polarity. The first electrode tab may be formed in a rod that has its inside filled.

The vertical section along the length of the first electrode tab may have an elliptical shape.

The first electrode tab may have a width that is about one third of the winding width of the electrode assembly.

Insulating members may be attached to the first and second electrode tabs along outer circumferential surfaces of the first and second electrode tabs, wherein the insulating members are positioned at boundaries between the first and second electrode plates and the first and second electrode tabs protruding outsides the electrode assembly.

The outer circumferential surface of the first electrode tab to which the insulating member is attached may comprise a groove.

The depth of the groove may be identical to the thickness of the insulating member.

The first and second electrode tabs may be fixed to the first and second electrode plates through fusing, respectively.

Each of the first and second electrode plates may comprise an active material layer formed by an active material coated on both surfaces thereof and a non-coated portion on which the active material is not coated. The first and second electrode tabs may be coupled to the non-coating portions, respectively.

According to an aspect of the present invention, there is provided a secondary battery including: the electrode assembly; an outer casing that accommodates the electrode assembly, the outer casing having an opened portion; and a cover that seals the opened portion of the outer casing.

The first and second electrode tabs may be electrically connected to first and second electrode lead tabs exposed to an exterior of the cover, respectively.

The vertical section in the lengthwise direction of the first electrode tab may be formed to have the same size as the vertical section in the lengthwise direction of the first electrode lead tab.

The first and second electrode tabs may be connected to the first and second electrode tabs through welding, respectively.

The first and second electrode tabs may be connected to the first and second electrode tabs through fusing, respectively.

The cover may comprise first and second holes through which the first and second electrode lead tabs pass, respectively.

The outer casing or the cover may be formed of any one material selected from nylon and polypropylene.

When the cover is formed as a can, insulating gaskets may be further formed on interior surfaces of the first and second holes, respectively.

The secondary battery may be applied to batteries of 5Ah or more.

According to embodiments of the present invention, in the winding of an electrode assembly, the deformation of the electrode assembly is inhibited by a rod-shaped electrode tab, so that it is possible to block heat generated from the secondary battery.

Further, the area of the electrode tab may be broadened, so that it is possible to lower the resistance of the secondary battery and to implement a high-power battery.

### BRIEF DESCRIPTION OF THE DRAWINGS

The accompanying drawings, together with the specification, illustrate embodiments of the present invention, and together with the description, serve to explain the principles of embodiments of the present invention.

FIG. 1 is a perspective view showing a state before an electrode assembly is wound according to an embodiment of the present invention.

FIG. 2 is a perspective view showing a state in which an electrode assembly is wound according to an embodiment of the present invention.

FIG. 3 is an exploded perspective view showing a secondary battery according to an embodiment of the present invention.

FIG. 4 is an assembled perspective view showing the secondary battery according to an embodiment of the present invention.

FIG. 5 is a perspective view showing a first electrode tab according to another embodiment.

FIG. 6 is an exploded perspective view showing a secondary battery according to still another embodiment.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

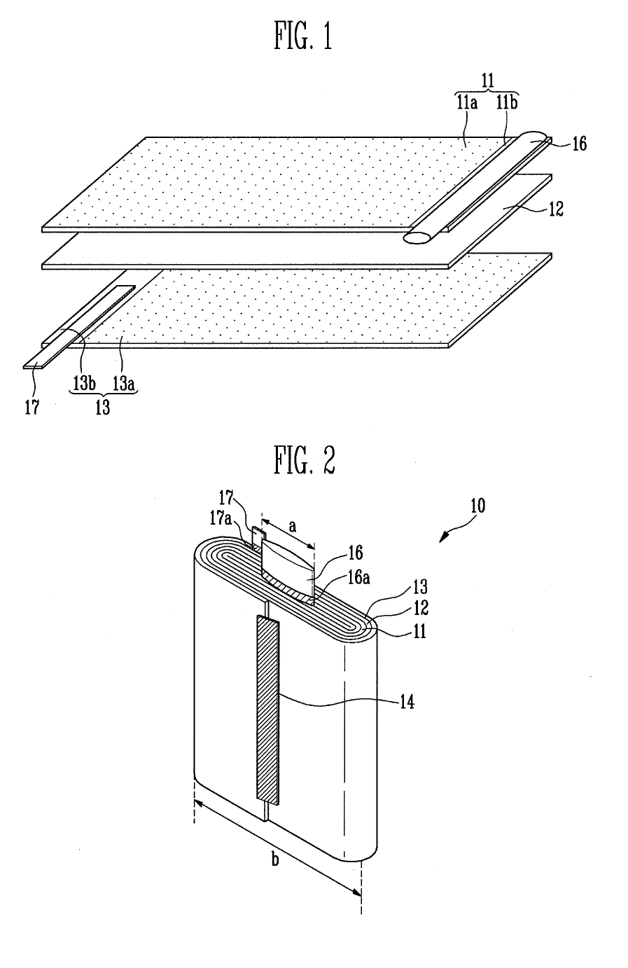

FIG. 1 is a perspective view showing a state before an electrode assembly is wound according to an embodiment of the present invention.

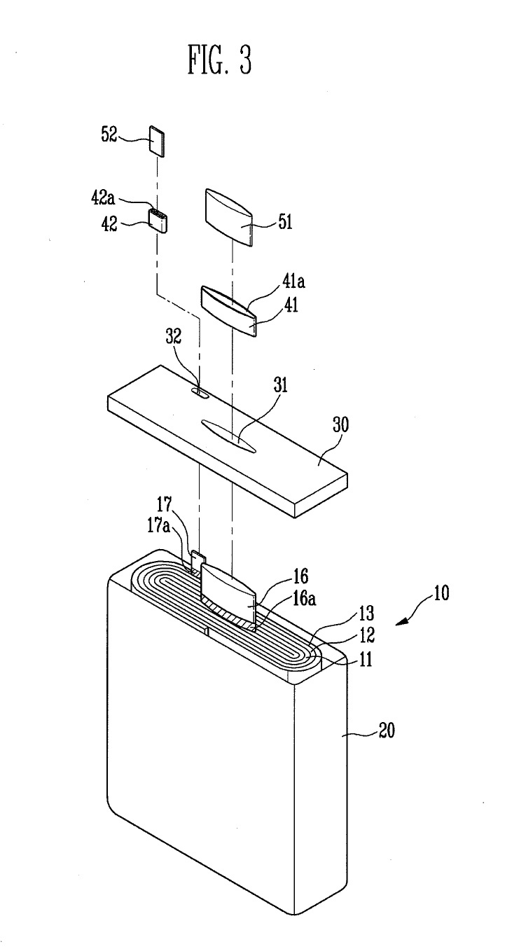

Referring to FIG. 1, the electrode assembly 10 (see FIG. 2) may includes a positive electrode plate 11, a negative electrode plate 13 and a separator 12 interposed therebetween. In this instance, a positive electrode tab 16 is fixed to one side of the positive electrode plate 11, and a negative electrode tab 17 is fixed to the other side of the negative electrode plate 17.

The positive electrode plate 11 may include a positive electrode active material layer 11a formed by coating an active material on at least one surface thereof and a positive electrode non-coated portion 11b on which the active material is not coated. Like the positive electrode plate 11, the negative electrode plate 13 may include a negative electrode active material layer 13a and a negative electrode non-coated portion 13b. Here, the positive electrode non-coated portion 11b is formed at one end portion of the positive electrode plate 11, and the negative electrode non-coated portion 13b is formed at an end portion of the negative electrode plate 13 opposite the end portion of the positive electrode non-coated portion 11b so as not to be overlapped with the positive electrode non-coated portion 11b.

The positive and negative electrode tabs 16 and 17 may be coupled to the positive and negative electrode non-coated portions 11b and 13b, respectively. According to an embodiment, one side of the positive and negative electrode tabs 16 and 17 may be fixed to the positive and negative electrode non-coated portions 11b and 13b through fusing, respectively. The other sides of the positive and negative electrode tabs 16 and 17, which are not fused to the positive and negative electrode non-coated portions 11b and 13b, may be extracted to the outside of the positive and negative electrode plates 11 and 13, respectively.

Here, the positive electrode tab 16 may be formed in the shape of a rod that has its inside filled, and the negative electrode tab 17 may be formed in a flat shape. The vertical section in the length direction of the positive electrode tab 16 may be formed in an elliptical shape. The shape of the positive electrode tab 16 may be modified as described above, so that it is possible to prevent heat generated from a positive electrode in the charge or discharge of a secondary battery and to lower the resistance of the positive electrode.

Although the method of forming the positive and negative electrode plates 11 and 13 may be different depending on the kind of the secondary battery, the positive and negative electrode plates 11 and 13 are generally formed by coating active materials on collectors that are base metal materials, drying the collectors and then roll-pressing and cutting the collectors.

The positive electrode plate 11 may include a positive electrode collector having excellent conductivity, with the positive electrode active material layer 11a formed on at least one surface of the positive electrode collector, and not formed on the positive electrode non-coated portion 11b. Aluminum (Al) having excellent conductivity may be used as the positive electrode collector. The positive electrode active material layer 11a may be formed by coating a positive slurry on at least one surface of the positive electrode collector. In the positive slurry, a positive electrode active material, a conducting agent and a positive electrode binder may be mixed together.

According to an embodiment, the positive electrode active material may generate electrons by participating in a positive electrode chemical reaction of a lithium secondary battery, and the conducting agent may transfer the electrons generated in the positive electrode active material to the positive electrode collector. The positive electrode binder can bind the positive electrode active material and the conducting agent to each other so as to maintain the mechanical strength of the positive electrode plate 11.

Although lithium complex metal oxides such as LiCoO₂, LiMn₂O₄, LiNiO₂, LiNi-xCoxO₂(0<x>1) and LiMnO₂ may be used as the positive electrode active material, embodiments of the present invention are not limited thereto.

The negative electrode plate 13 may include a negative electrode collector made of a conductive metal sheet, a negative electrode active material layer 13a formed by coating a negative electrode active material on at least one surface of the negative electrode collector, and a negative electrode non-coated portion 11b on which the negative electrode active material is not coated. The negative electrode active material layer 13a may include a negative electrode active material and a negative electrode binder that binds the negative electrode active material to the negative electrode collector.

Here, the negative electrode collector may be formed of copper (Cu) or nickel (Ni). Although any one of hard carbon, soft carbon and graphite may be mainly used as the negative electrode active material, embodiments of the present invention are not limited thereto.

The separator 12 may be interposed between the positive and negative electrode plates 11 and 13, and an insulating thin film having high ion transmittance and mechanical strength may be used as the separator 12. The separator 12 can prevent an electrical short circuit between positive and negative electrodes in the charge or discharge of a battery, and can enable only the movement of lithium ions. In order to prevent the occurrence of short circuiting caused by contact of the circumferences of the positive and negative electrode plates 11 and 13, the width and length of the separator 12 may be formed to be slightly larger than those of each of the positive and negative electrode plates 11 and 13.

The separator 12 may be formed of a micro-porous material that allows movement of lithium ions. For example, the separator 12 may be formed of polyethylene (PE), polypropylene (PP), polyolefin resin or a derivative thereof, which has a plurality of micro-pores. However, embodiments of the present invention are not limited thereto.

FIG. 2 is a perspective view showing a state in which an electrode assembly is wound according to an embodiment of the present invention.

Referring to FIG. 2, the electrode assembly 10 according to this embodiment is wound so that the rod-shaped positive electrode tab 16 is positioned in the center of the electrode assembly 10. A finishing tape 14 may be attached to an outer surface of the wound-type electrode assembly 10 so that a finished portion of the electrode assembly 10 is not unfastened.

The vertical section in the lengthwise direction of the positive electrode tab 16 may be formed in an elliptical shape. Accordingly, the electrode assembly 10 wound toward the side at which the negative electrode tab 17 is formed from the side at which the positive electrode tab 16 is formed can be an elliptical shape.

Here, the width ‘a’ of the positive electrode tab 16 may be formed to be about ⅓ of the winding width ‘b’ of the electrode assembly 10. For example, if the width ‘a’ of the positive electrode tab 16 may be represented as 1T, the winding width ‘b’ of the electrode assembly 10 may be represented as 3T. The width ‘a’ of the positive electrode tab 16 may be obtained by subtracting 2T from the winding width ‘b’ of the electrode assembly 10. If the width ‘a’ of the positive electrode tab 16 is formed very small, it can become difficult to output high power because the area of the positive electrode tab 16 is not broad. If the width ‘a’ of the positive electrode tab 16 is formed very large, the area of the electrode plate is decreased, and therefore, the charge amount of the secondary battery may be reduced.

Insulating members 16a or 17a may be attached to the positive and negative electrode tabs 16 and 17 along circumferential surfaces of the positive and negative electrode tabs 16 and 17 positioned at boundaries at which the positive and negative electrode tabs 16 and 17 are protruded to the outsides of the positive and negative electrode plates 11 and 13, respectively.

The insulating members 16a and 17b can prevent short circuits from being generated by contact between the positive and negative electrode tabs 16 and 17 with the electrode plates 11 and 13 having different polarities, respectively. The insulating member 16a or 17a can function to block heat generated from the positive or negative electrode tab 16 or 17 and to allow the electrode assembly 10 to not be pressed by an edge of the positive or negative electrode tab 16 or 17.

As described above, the positive electrode tab 16 may be formed in the shape of an elliptical rod, so that it is possible to prevent heat generated from the positive electrode tab 16. The area may be broadened by filling in the inside of the positive electrode tab 16, so that it is possible to lower the resistance of the positive electrode tab 16. In this instance, the positive electrode tab 16 formed in the shape of a rod that has its inside filled may have a resistive index of about ⅔ or so with respect to the positive electrode tab formed in the shape of a rod that has its inside empty. Since the positive electrode tab 16 in the illustrated embodiment is positioned at the center of the electrode assembly 10, it is possible to prevent the shape of the electrode assembly 10 from being deformed.

According to embodiments of the present invention, a battery cell having a rod-shaped electrode tab has more improved performance over that having a general electrode tab. For a secondary battery manufactured as a battery cell according to an embodiment, the heat generation index of the rod-shape electrode tab is decreased when compared to that of the conventional electrode tab, with a charge or discharge rate of about 5° C. to about 10° C. or higher. That is, the heat generation index is decreased from a level of about 50° C. to a level of about 30° C. For a secondary battery manufactured as a battery pack according to an embodiment, the resistance heat between the rod-shaped electrode tab and a terminal of the battery pack may also be decreased to about 30% or so. If the rod-shaped electrode tab according to an embodiment of the present invention is applied as described above, it is possible to prevent certain phenomenon, such as a decrease in capacity due to heat generation, and to improve an unequal charge/discharge depth in the charge or discharge of the secondary battery. More specifically, according to embodiments of the present invention, the difference in temperature between the electrode tab and the bottom of the battery cell may be decreased from about 15° C. to about 9° C. based on the internal temperature of the secondary battery.

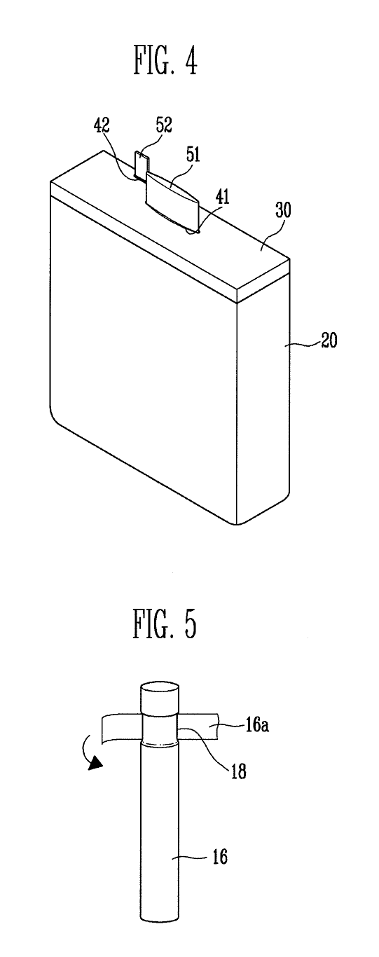

FIG. 3 is an exploded perspective view showing a secondary battery according to an embodiment of the present invention. FIG. 4 is an assembled perspective view showing the secondary battery according to the embodiment of the present invention.

Referring to FIGS. 3 and 4, the secondary battery according to this embodiment includes an electrode assembly 10, an outer casing 20 having an opened portion, and a cover 30 that covers the opened portion.

The electrode assembly 10 may have a shape wound so that the positive electrode tab formed in the shape of an elliptical rod as described above is positioned at the center of the electrode assembly 10. The outer casing 20 having the opened portion may accommodate the electrode assembly 10, and the opened portion of the outer casing 20 may be sealed by the cover 30.

Here, the positive and negative electrode tabs 16 and 17 may be electrically connected to positive and negative electrode lead tabs 51 and 52 exposed to the outsides of the cover 30, respectively. In the illustrated embodiment, the positive and negative electrode lead tabs 51 and 52 may be connected to the positive and negative electrode tabs 16 and 17 through welding or fusing, respectively. The positive and negative electrode lead tabs 51 and 52 are portions to be electrically connected to a protection circuit module in a subsequent step. Hereinafter, the positive and negative electrode tabs 16 and 17 will be described using the term ‘positive and negative electrode lead tabs’, respectively.

First and second holes 31 and 32 through which the positive and negative electrode lead tabs 51 and 52 pass, respectively, may be formed in the cover 30. In a case where the outer casing 20 and the cover 30 are formed as a can, insulating gaskets 41 and 42 may be further formed in the insides of the respective first and second holes 31 and 32 for the purpose of insulation between the cover 30 and the positive and negative electrode lead tabs 51 and 52. Through-holes 41a and 42a may be formed at the centers of the insulating gaskets 41 and 42, so that the positive and negative electrode lead tabs 51 and 52 can be connected to the positive and negative electrode tabs 16 and 17 while passing through the through-holes 41a and 42a, respectively.

In this instance, the vertical section in the lengthwise direction of the rod-shaped positive electrode tab 16 may be formed to have a size identical to that of the vertical section in the lengthwise direction of the positive electrode lead tab 51. Accordingly, when the rod-shaped positive electrode tab according to an embodiment of the present invention is used, it is possible to block the generation of heat from the positive electrode during the charging or discharging of the secondary battery, as compared with when the conventional flat-shaped positive electrode tab is used.

As described above, it is possible to block the heat generation from the positive electrode, to prevent the deformation of the electrode assembly 10 and to lower the resistance of the positive electrode. Accordingly, the secondary battery according to embodiments of the present invention can be applied to medium- and large-sized batteries of 5Ah or more.

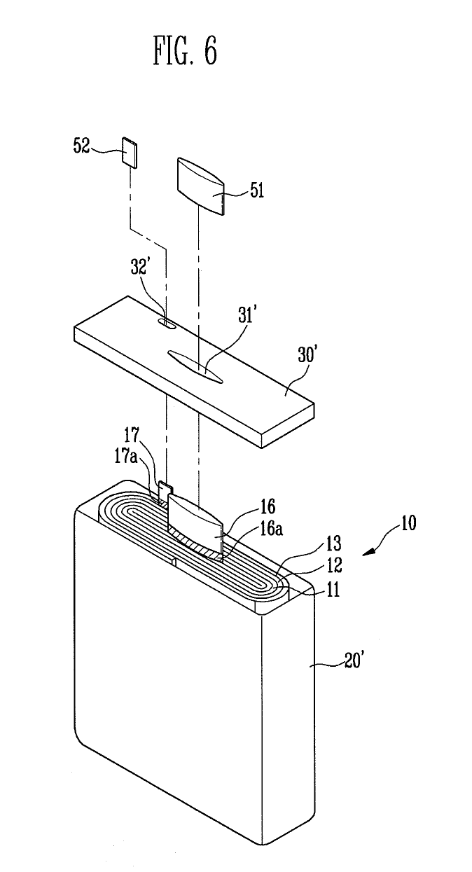

FIG. 5 is a perspective view showing a first electrode tab according to another embodiment.

Referring to FIG. 5, like the aforementioned embodiment, the positive electrode tab 16 according to this embodiment may be formed in the shape of a rod that has its inside filled. The vertical section in the length direction of the positive electrode tab 16 may be formed in an elliptical shape.

A groove 18 may be further formed on an outer circumferential surface of the positive electrode tab 16 extracted from the electrode assembly 10 (see FIG. 2). That is, the groove 18 may be formed along the outer circumferential surface of the positive electrode tab 16 positioned at a boundary at which the positive electrode tab 16 is protruded to the outside of the positive electrode plate 11 (see FIG. 2). The groove 18 may be a region in which an insulating member 16a is attached to the positive electrode tab 16. In this instance, the insulating member 16a can prevent a short circuit from being generated by contact between the positive electrode tab 16 and the negative electrode plate 13 (see FIG. 2).

Here, the depth of the groove 18 may be formed to be identical to the thickness of the insulating member 16a, and thus the outer circumferential surface of the positive electrode tab 16 having the insulating member 16 attached thereto can be formed to have a constant thickness. Accordingly, when the positive electrode tab 16 is wound to be positioned at the center of the electrode assembly 10, the positive electrode plate 11 (see FIG. 2), the separator 12 (see FIG. 2) and the negative electrode plate 13 (see FIG. 2) can be precisely aligned without their dispersion.

FIG. 6 is an exploded perspective view showing a secondary battery according to another embodiment.

Referring to FIG. 6, the secondary battery according to this embodiment includes an electrode assembly 10, an outer casing 20 that accommodates the electrode assembly 10, and a cover 30′. In this embodiment, descriptions of components identical to those of the aforementioned embodiment will not be provided.

In FIG. 6, the outer casing 20′ and the cover 30′ may be formed of an insulating material such as nylon or polypropylene. In this case, it is unnecessary to provide an insulating gasket for insulation between the cover 30′ and the positive and negative electrode lead tabs 51 and 52. Although not shown in this figure, materials for sealing, such as silicon, may be further formed between a first hole 31′ and the positive electrode lead tab 51 and between a second hole 32′ and the negative electrode lead tab 52, respectively.

While the present invention has been described in connection with certain embodiments, it is to be understood that the invention is not limited to the disclosed embodiments, but on the contrary, is intended to cover various modifications and equivalent arrangements included within the spirit and scope of the appended claims, and equivalents thereof.

What is claimed is:

1. An electrode assembly comprising:
a first electrode plate having a first electrode tab coupled to an end portion of the first electrode plate;
a second electrode plate having a second electrode tab coupled to an end portion of the second electrode; and
a separator interposed between the first and second electrode plates,
wherein the first electrode tab is formed in a rod shape positioned at a center of the electrode assembly.

2. The electrode assembly according to claim 1, wherein the first electrode tab has a positive polarity.

3. The electrode assembly according to claim 1, wherein the first electrode tab is formed in a rod shape that has its inside filled with a material.

4. The electrode assembly according to claim 1, wherein the first electrode tab comprises a vertical section along its length having an elliptical shape.

5. The electrode assembly according to claim 1, wherein the first electrode tab comprises a width that is about one third of a winding width of the electrode assembly.

6. The electrode assembly according to claim 1, wherein insulating members are attached to the first and second electrode tabs along outer circumferential surfaces of the first and second electrode tabs, wherein the insulating members are positioned at boundaries between the first and second electrode plates and the first and second electrode tabs protruding outside the electrode assembly.

7. The electrode assembly according to claim 6, wherein the outer circumferential surface of the first electrode tab to which the insulating member is attached comprises a groove.

8. The electrode assembly according to claim 7, wherein the groove comprises a depth that is identical to the thickness of the insulating member.

9. The electrode assembly according to claim 1, wherein the first and second electrode tabs are respectively coupled to the first and second electrode plates through fusing.

10. The electrode assembly according to claim 1, wherein each of the first and second electrode plates is formed of a coated portion having an active material coated on both surfaces of the first and second electrode plates and a non-coated portion on which the active material is not coated, and wherein the first and second electrode tabs are respectively coupled to the non-coated portions.

11. A secondary battery comprising:
the electrode assembly according to claim 1;
an outer casing that accommodates the electrode assembly, the outer casing having an opened portion; and
a cover that seals the opened portion of the outer casing.

12. The secondary battery according to claim 11, wherein the first and second electrode tabs are respectively connected to first and second electrode lead tabs exposed to an exterior of the cover.

13. The secondary battery according to claim 12, wherein the first electrode tab comprises a vertical section along its length, and the first electrode lead tab comprises a vertical section along its length, and the vertical section of the first electrode tab has a size identical to a size of the vertical section of the first electrode lead tab.

14. The secondary battery according to claim 12, wherein the first and second electrode lead tabs are respectively connected to the first and second electrode tabs through welding.

15. The secondary battery according to claim 12, wherein the first and second electrode lead tabs are respectively connected to the first and second electrode tabs through fusing.

16. The secondary battery according to claim 12, wherein the cover comprises first and second holes through which the first and second electrode lead tabs respectively pass.

17. The secondary battery according to claim 16, wherein the outer casing or the cover comprises nylon or polypropylene.

18. The secondary battery according to claim 17, wherein the cover is formed as a can, and insulating gaskets are formed on interior surfaces of the first and second holes.

19. The secondary battery according to claim 11, wherein the secondary battery is configured to be used for batteries of 5Ah or more.
